(19) United States
(12) Patent Application Publication
(10) Pub. No.: US 2015/0304461 A1
(43) Pub. Date: Oct. 22, 2015

(54) Network interface unit and method for operating a network interface unit

(71) Applicant: Robert Bosch GmbH, Stuttgart (DE)

(72) Inventors: Andreas Brune, Backnang (DE); Herbert Leuwer, Backnang (DE); Christopher Pohl, Duesseldorf (DE)

(21) Appl. No.: 14/685,880

(22) Filed: Apr. 14, 2015

(30) Foreign Application Priority Data
Apr. 17, 2014 (DE) 10 2014 207 413.4

(51) Int. Cl. H04L 29/06; H04L 12/66

(52) U.S. Cl. CPC H04L 69/22; H04L 12/66

(57) ABSTRACT

A network interface unit includes: at least one input terminal for receiving Ethernet data packets; at least one output terminal; and a segmentation unit configured for (i) segmenting at least one of a received Ethernet data packet and an Ethernet data packet modified by the network interface unit into at least one data segment having a predefined length, and (ii) for outputting the at least one data segment via the output terminal.

### BACKGROUND OF THE INVENTION

1. Field of the Invention

The present invention relates to a network interface unit which includes at least one input terminal for receiving Ethernet data packets, and, at least one output terminal. Moreover, the present invention relates to a method for operating this type of network interface unit.

2. Description of the Related Art

Network interface units of the above-mentioned type are known, and are designed, for example, to receive and/or send so-called Ethernet data packets, i.e., network data packets which correspond in particular to Institute of Electrical and Electronics Engineers (IEEE) Standard 802.3. The transmission of the Ethernet data packets takes place in a manner known per se, via a medium (shared medium) which is optionally shared with other network interface units, in particular via electrical and/or optical data connections. A disadvantage of the known network interface units is their low degree of flexibility and thus, limited practical utility.

### BRIEF SUMMARY OF THE INVENTION

The object of the present invention is to improve a network interface unit and an operating method for a network interface unit in such a way that the above-mentioned disadvantages of the related art are avoided, and in particular greater flexibility and enhanced practical utility are provided.

For the network interface unit of the type mentioned at the outset, this object is achieved according to the present invention by providing a segmentation unit which is designed for segmenting a received Ethernet data packet and/or an Ethernet data packet which is modified by the network interface unit into at least one data segment having a predefinable length, and for outputting the at least one data segment via the output terminal. In this way, data segments having a predefinable length, in particular a constant or variable length, may advantageously be output to the output terminal, as the result of which degrees of freedom, in particular compared to conventional network interface units, are possible with regard to the configuration of a data sink which receives the output data segments.

In particular, an abstraction or transformation of the data received from the network interface unit in the form of the one or multiple Ethernet data packets into at least one other data format is possible. For example, this type of adaptation may take place by specifying the length of the data segments to be output. It is also advantageous that, due to the network interface unit according to the present invention, the Ethernet data packets, which, as is generally known, have differing packet lengths from a minimum of approximately 64 bytes to a maximum of approximately 1518 bytes, optionally in addition to a preamble and a start frame delimiter (SFD), are dividable into data segments of constant length, so that a deterministic run time or processing time of the data segments in a processing unit downstream from the network interface unit according to the present invention is possible.

In one advantageous specific embodiment, it is provided that the segmentation unit is designed for assigning a data segment header to each data segment, the segmentation unit preferably also being designed for outputting the data segment header via the output terminal. It is thus possible to form an association of the individual data segments with a sequence, for example the data sequence within the segmented Ethernet data packet which is received from the network interface unit, which is also usable within processing units downstream from the network interface unit. In one specific embodiment, a constant size (length in bytes, for example) may be provided for the data segment header in a particularly advantageous manner, so that advantages also result with respect to the processing of the data segment header, such as a constant memory requirement for each data segment header, constant throughput time, or processing time, etc.

In another advantageous specific embodiment, it is provided that the output terminal a) includes a first output buffer for at least temporarily storing one or multiple data segments generated by the segmentation unit and/or b) includes a second output buffer for at least temporarily storing one or multiple data segment headers generated by the segmentation unit. In this way, the data segments formed by the network interface unit according to the present invention and/or their data segment headers may be at least temporarily buffered, for example prior to an output to a downstream processing unit. In addition, as a result of one specific embodiment, the buffering in the output buffer(s) allows processing of corresponding data with the buffered data (data segments and/or data segment headers), which may allow a conclusion that, for example, the buffered data (data segments and/or data segment headers) are not to be output at all to the downstream processing unit, in particular via the output terminal, so that the buffered data in question (data segments and/or data segment headers) may still be deleted from the buffer or the buffers prior to the output. Such a procedure is advantageous, for example, for an analysis of the content of the processed or buffered data (data segments and/or data segment headers), if the analysis shows that one or more of the processed or buffered pieces of data (data segments and/or data segment headers) is/are not considered for an output.

In another advantageous specific embodiment, an evaluation unit is provided which is designed for evaluating a received Ethernet data packet as a function of at least one predefinable criterion, as the result of which filtering of the Ethernet data packets, for example, is achievable.

In another advantageous specific embodiment, it is provided that the evaluation unit is designed for a) assigning an identifier (channel ID) to the received Ethernet data packet as a function of the evaluation and/or for b) modifying the received Ethernet data packet as a function of the evaluation in order to obtain a modified Ethernet data packet, the evaluation unit preferably being designed for outputting the modified Ethernet data packet to the segmentation unit. In one specific embodiment, for example, the assigned identifier may also be output to the segmentation unit. For example, the segmentation unit may write the assigned identifier into one or multiple data segment headers to produce data segments which correspond to the Ethernet data packet or the modified Ethernet data packet. Alternatively or additionally, for example within the scope of the above-described modification of the Ethernet data packet, the identifier may be written directly into one or multiple data segments, thus allowing a type of in-band signaling of the identifier in the data segments.

In another advantageous specific embodiment, it is provided that the evaluation unit is designed for carrying out one or more of the following steps: —removing predefinable portions of the received Ethernet data packet (stripping), in particular at least partially removing header data, —replacing predefinable portions of the received Ethernet data packet. In this way, the data volume for the data segments to be output, or their number, and optionally the corresponding number of data segment headers, may be reduced, thus relieving a processing unit downstream from the network interface unit according to the present invention.

In another advantageous specific embodiment, it is provided that a secondary input terminal for receiving data segments and data segment headers corresponding to the data segments is provided, a packet processing unit being provided which is designed for forming at least one Ethernet data packet as a function of data segments and/or data segment headers received via the secondary input terminal. The network interface unit according to the present invention may thus advantageously combine data segments, which are transmitted from an external processing unit, for example, into Ethernet data packets for a standardized output via a suitable Ethernet-compatible medium.

Examples of specific embodiments of the present invention are explained below with reference to the drawing.

### BRIEF DESCRIPTION OF THE DRAWINGS

FIG. 1 schematically shows a network interface unit according to a first specific embodiment.

FIG. 2 schematically shows a network interface unit according to a second specific embodiment.

FIG. 3 schematically shows aspects of a network interface unit according to a third specific embodiment.

FIG. 4 schematically shows a network interface unit according to a fourth specific embodiment.

FIG. 5 schematically shows a first aspect of the filtering according to one specific embodiment.

FIG. 6 schematically shows a second aspect of the filtering according to one specific embodiment.

FIGS. 7a and 7b schematically show aspects of the segmentation according to further specific embodiments.

FIG. 8 schematically shows one aspect of an output interface according to one specific embodiment.

FIG. 9 schematically shows one aspect of a packet processing unit according to one specific embodiment.

FIGS. 10a and 10b each schematically show a flow chart according to one specific embodiment.

### DETAILED DESCRIPTION OF THE INVENTION

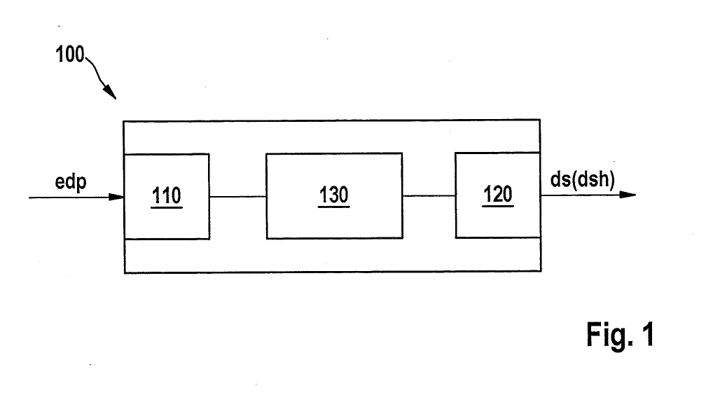

FIG. 1 schematically shows a network interface unit 100 according to a first specific embodiment. Network interface unit 100 includes an input terminal 110 for receiving Ethernet data packets edp, for example according to IEEE Standard 802.3.

In one specific embodiment, input terminal 110 is, for example, directly connected to an Ethernet switch (not shown), preferably via an interface of the Serial Gigabit Media Independent Interface (SGMII) type. Alternatively, input terminal 110 may be connected, for example, to an interface which operates on the bit transmission layer (PHY layer) of the ISO/OSI base reference model via an interface of the Reduced Gigabit Media Independent Interface (RGMII) type. In general, above-mentioned Ethernet data packets edp may be supplied to network interface unit 100 via input terminal 110. In one specific embodiment, input terminal 110 is designed for transmitting the Gigabit Ethernet (GbE) type.

According to the present invention, network interface unit 100 includes at least one output terminal 120 and one segmentation unit 130, which is designed for segmenting a received Ethernet data packet edp into at least one data segment ds having a predefinable length, and for outputting the at least one data segment ds via output terminal 120. In this way, data segments ds having a predefinable length, in particular a constant or variable length, may advantageously be output to output terminal 120, as the result of which degrees of freedom, in particular compared to conventional network interface units, are possible with regard to the configuration of a data sink (not shown) which receives the output data segments.

In particular, an abstraction or transformation of the data received from network interface unit 100 in the form of the one or multiple Ethernet data packets edp into at least one other data format is possible. For example, this type of adaptation may take place by specifying the length of data segments ds to be output. It is also advantageous that, due to network interface unit 100 according to the present invention, Ethernet data packets edp, which, as is generally known, have differing packet lengths from a minimum of approximately 64 bytes to a maximum of approximately 1518 bytes, optionally in addition to a preamble and a start frame delimiter (SFD), are dividable into data segments of constant length, so that a deterministic run time or processing time of data segments ds in a processing unit (not shown) downstream from network interface unit 100 according to the present invention is possible.

In one advantageous specific embodiment, segmentation unit 130 is designed for assigning a data segment header dsh to each data segment ds, segmentation unit 130 preferably also being designed for outputting data segment header dsh via output terminal 120.

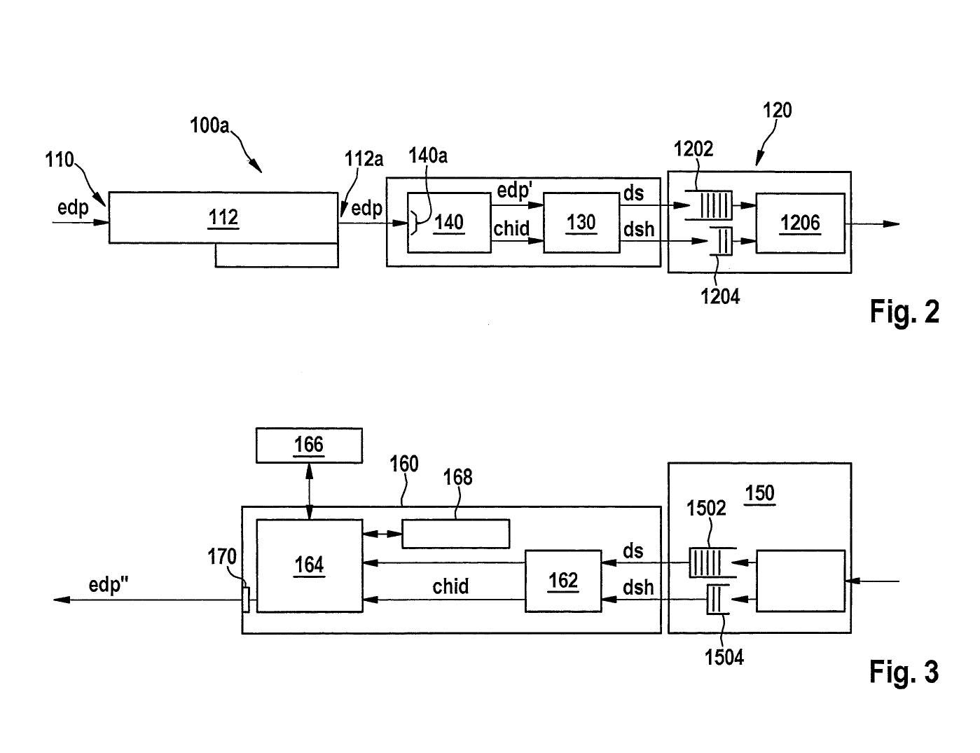

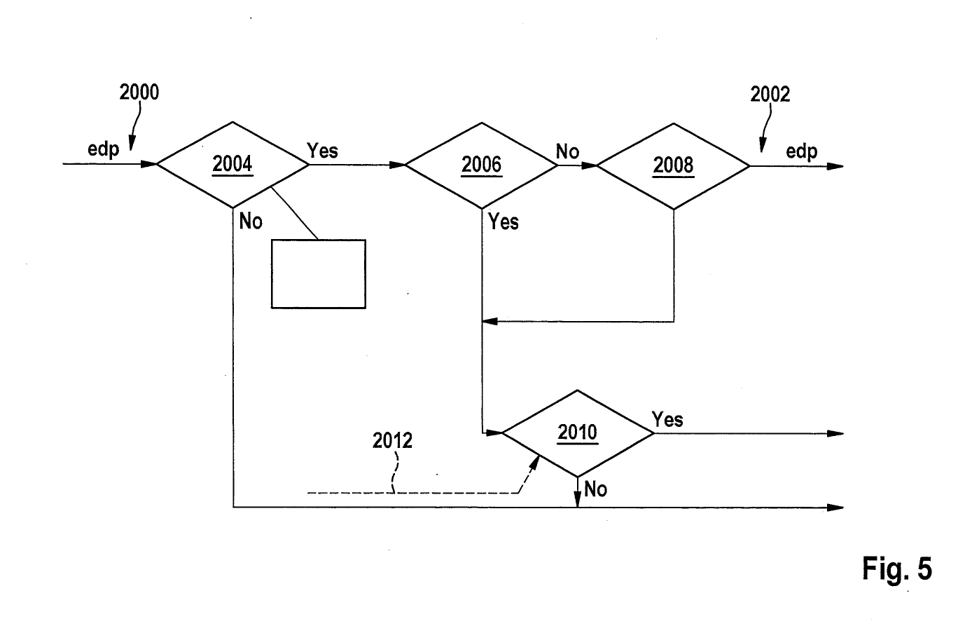

FIG. 2 schematically shows a network interface unit 100a according to a second specific embodiment. Network interface unit 100a, as described above with reference to FIG. 1, includes an input terminal 110 for receiving one or multiple Ethernet data packets edp. An optional service filter unit 112, situated downstream from input terminal 110 in the present specific embodiment, is designed for filtering incoming Ethernet data packets edp according to one or multiple predefinable criteria. One detailed exemplary embodiment of a service filter unit 112 is described in greater, detail below with reference to FIG. 5.

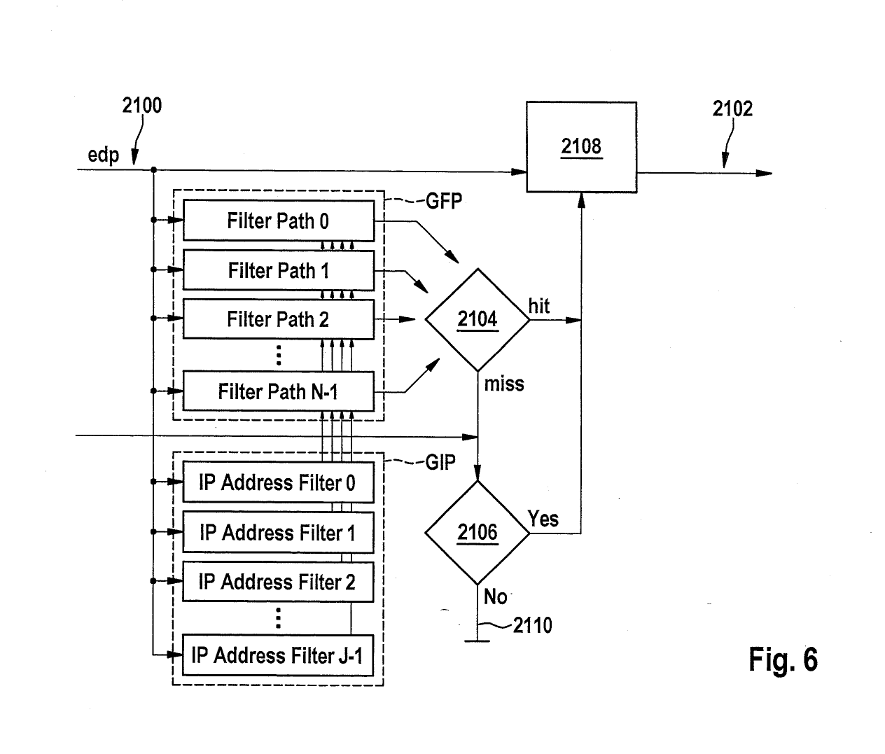

Situated downstream from service filter unit 112 is an evaluation unit 140, which receives filtered Ethernet data packets at its input 140a which may possibly be output by service filter unit 112 at its output 112a, and which is designed for evaluating a received Ethernet data packet as a function of at least one predefinable criterion. One detailed exemplary embodiment of an evaluation unit 140 is described in greater detail below with reference to FIG. 6.

In one preferred specific embodiment, evaluation unit 140 is designed for a) assigning an identifier chid (channel ID) to the received Ethernet data packet as a function of the evaluation and/or for b) modifying the received Ethernet data packet as a function of the evaluation in order to obtain a modified Ethernet data packet, evaluation unit 140 preferably being designed for outputting the modified Ethernet data packet to segmentation unit 130.

In another preferred specific embodiment, evaluation unit 140 is designed for carrying out one or more of the following steps: removing predefinable portions of the received Ethernet data packet, in particular at least partially removing header data (for example, removing the preamble and/or SFD and/or destination MAC address and/or source MAC address and/or VLAN data and/or check sum data (CRC)), and replacing predefinable portions of the received Ethernet data packet.

In another preferred specific embodiment, evaluation unit 140 is designed for subjecting received Ethernet data packets or their useful data content (payload) to an evaluation which extends into layer 3 (network layer) or even into layer 4, i.e., the transport layer, of the ISO/OSI base reference model (in other specific embodiments, an evaluation is also conceivable which includes layers 5, 6). In other words, in the present preferred specific embodiment, evaluation unit 140 may carry out a very extensive analysis of the received Ethernet data packets or their useful data content. As a function of the analysis, individual Ethernet data packets edp, edp′ may, for example, be discarded, filtered in some other way, and/or modified. It may thus be advantageously achieved that, for example, some TCP, IP, or other data streams which enter into unit 100 in the form of Ethernet data packets are not processed, i.e., segmented, at all by segmentation unit 130 according to the present invention, due to the fact that they are not suitable for the output in the form of data segments ds, for example because a downstream processing unit does not want, or is not supposed, to process the IP data streams in question. The efficiency of the present invention with regard to the generation of data segments ds is further increased in this way.

In another preferred specific embodiment, segmentation unit 130 is designed for segmenting an Ethernet data packet edp′ which is modified by network interface unit 100, in particular by evaluation unit 140 described above, into at least one data segment ds having a predefinable length, and for outputting the at least one data segment ds via output terminal 120.

In another preferred specific embodiment, output terminal 120 includes [a)] a first output buffer 1202 for at least temporarily storing one or multiple data segments ds generated by segmentation unit 130 and/or b) includes a second output buffer 1204 for at least temporarily storing one or multiple data segment headers dsh generated by segmentation unit 130. Optionally, an output control logic system 1206 may also be present which controls the output of data segments ds and/or data segment headers dsh, in particular of data segments ds or data segment headers dsh which are at least temporarily stored in first output buffer 1202 or in second output buffer 1204.

FIG. 3 schematically shows aspects of a network interface unit according to a third specific embodiment. A secondary input terminal 150 for receiving data segments and data segment headers corresponding to the data segments is provided. Such data segments or data segment headers may originate, for example, from a data source not depicted in FIG. 3. In addition, a packet processing unit 160 is provided which is designed for forming at least one Ethernet data packet edp″ as a function of data segments and/or data segment headers received via secondary input terminal 150.

Configuration 150, 160 according to FIG. 3 may particularly advantageously be combined with the components or network interface units 100, 100a described above with reference to FIGS. 1, 2. In particular, an output terminal 170 of packet processing unit 160 may be designed analogously to input terminal 110 (FIGS. 1, 2) in such a way that the output terminal may be connected directly to an Ethernet switch (not shown), preferably via an interface of the Serial Gigabit Media Independent Interface (SGMII) type.

Alternatively, output terminal 170 may be connected, for example, to an interface which operates on the bit transmission layer (PHY layer) of the ISO/OSI base reference model via an interface of the Reduced Gigabit Media Independent Interface (RGMII) type.

In general, network interface unit 100, 100a according to the present invention may output Ethernet data packets edp″, formed by packet processing unit 160, to an Ethernet network via output terminal 170, for example via the same or a similar medium to which input terminal 110 is also connectable. In one specific embodiment, output terminal 170 is designed for transmitting the Gigabit Ethernet (GbE) type.

In one preferred specific embodiment, packet processing unit 160 includes a combination unit 162 which on the input side accepts data segments ds and/or data segment headers dsh from secondary input terminal 150 and uses one or multiple data segments or their data segment headers in order to generate one or multiple Ethernet data packets or portions of Ethernet data packets therefrom. In one specific embodiment, combination unit 162 may be designed, for example, for generating a useful data packet (payload), which is suitable for forming an Ethernet data packet edp″, as a function of one or multiple data segments or the corresponding data segment headers. Combination unit 162 relays its output data (for example, aggregated data of multiple data segments ds and/or identifiers chid) to a packet construction unit 164.

In one specific embodiment, combination unit 162 at its input analyzes incoming data segment headers dhs, identifies a first data segment ds for an Ethernet data packet edp″ to be created and optionally further subsequent data segments which likewise are to be an integral part of Ethernet data packet edp″ to be created, and signals this to a packet construction unit 164. In this regard, combination unit 162 may in particular also evaluate and use identifiers chid associated with the data segments.

As a result of another specific embodiment, packet construction unit 164 may add, for example, starting addresses and/or destination addresses (in particular MAC addresses) to the data received from combination unit 162 in order to complete an Ethernet data packet or continue its formation. Alternatively or additionally, unit 164 may form a check sum (cyclic redundancy check (CRC)) for Ethernet data packet edp″ to be formed.

Alternatively or additionally, unit 164 may have a so-called “protocol constructor” functionality or may support measures for data flow control (xon/xoff). In another advantageous specific embodiment, an address resolution protocol (ARP) database 166 is provided. In another specific embodiment, a buffer memory 168 may be provided which assists with the functioning of packet construction unit 164.

In yet another specific embodiment, secondary input terminal 150, similarly as for output terminal 120 (FIG. 2), may include one or multiple buffer memories, in the present case input buffers, in order to at least temporarily buffer incoming data segments or data segment headers at secondary input terminal 150. The input buffer in unit 150 for data segments which are incoming from an external data source is denoted by reference numeral 1502 in FIG. 3, and the input buffer for data segment headers is denoted by reference numeral 1504.

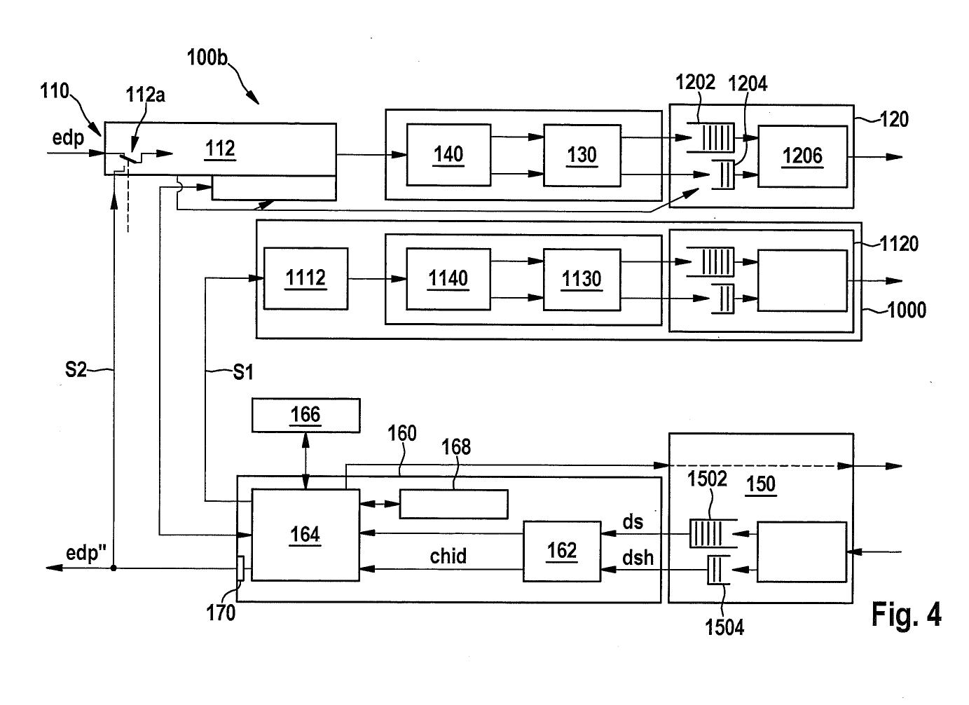

FIG. 4 shows another specific embodiment 100b of a network interface unit according to the present invention. Network interface unit 100b includes components 110, 112, 140, 130, 120 already described above with reference to FIG. 2, as well as components 150, 160, 170 already described above with reference to FIG. 3.

In addition, a feedback unit 1000 is provided which includes elements 1140, 1130 which are comparable to components 140, 130, respectively. An output terminal 1120 of feedback unit 1000 is essentially identical to output terminal 120.

Furthermore, feedback unit 1000 may also include a service filter unit 1112 which with regard to its functionality essentially corresponds to service filter unit 112.

The feedback of Ethernet data packets, generated with the aid of packet processing unit 160, to feedback unit 1000 via signal connection S1, depicted at the left in FIG. 4, from packet processing unit 160 or its component 164 to feedback unit 1000 is possible, so that a feedback loop may be closed via components 1000, 150, 160, S1.

A comparable feedback mechanism is also made possible via optional signal connection S2, which allows relaying of Ethernet data packets edp″ received at output 170 to input terminal 110 of network interface unit 100b. For example, at that location a switch 112a, which may be integrated into service filter unit 112, may control whether incoming Ethernet data packets edp from the shared medium (not shown), or instead, Ethernet data packets edp″ which are generated by packet processing unit 160, reach service filter 112, optionally for relaying to evaluation unit 140.

FIG. 5 schematically shows a first aspect of filtering, which may take place in service filter unit 112, for example (FIG. 2, FIG. 4). Ethernet data packets are received in an input section 2000, as denoted by reference character edp in FIG. 2, for example, and supplied to input terminal 110. After filtering as described in greater detail below, incoming Ethernet data packets edp are optionally output in an output area 2002, for example for relaying to evaluation unit 140 (see FIG. 2, FIG. 4).

In one preferred specific embodiment; an incoming Ethernet data packet edp is checked in a first query step 2004 as to whether its MAC destination address corresponds to the MAC address of network interface unit 100, 100a, 100b according to the present invention, or whether the MAC destination address corresponds to a broadcast address or multicast MAC address which the network interface unit would like to monitor. If this is the case, a branch is made to subsequent query step 2006, in which Ethernet data packet edp is checked for whether it contains a MAC control message of the MAC CTRL “pause” type. If not, a branch is made to subsequent query step 2008, which checks whether the Ethernet header of Ethernet data packet edp has a type field with the value 0x8808. If this is not the case, Ethernet data packet edp is supplied to output area 2002 for output to downstream unit 140 (FIG. 2).

If one of check steps 2006, 2008 shows that incoming Ethernet data packet edp contains an Ethernet control element of the “pause” type (pause frame), a branch is made to further query step 2010, in which a query is made as to whether or not Ethernet pause packets are evaluated. A control of query step 2010 may be implemented by a corresponding control signal 2012 which indicates whether or not a pause mode is active.

In further specific embodiments, service filter unit 112 (FIG. 2, FIG. 4) may provide different or supplementary filtering steps to the process described above with reference to FIG. 5, for example the general assessment of an Ethernet packet or Ethernet data frame as a function of a (MAC) source address and/or destination address and/or type information contained therein. For example, multicast Ethernet packets or also the described pause frames may thus also be checked or filtered.

FIG. 6 schematically shows a second aspect of the filtering according to one specific embodiment, which may be implemented in evaluation unit 140, for example (FIG. 2, FIG. 4).

Ethernet data packets edp, which are received directly at input terminal 110 or at an output of service filter unit 112, for example, come in in an input area 2100.

After filtering or evaluation by the structure according to FIG. 6 described in greater detail below, Ethernet data packets edp incoming in input area 2100 are optionally output in output area 2102 to a subsequent unit, such as segmentation unit 130 (FIG. 2, FIG. 4).

As a result of one specific embodiment, as is apparent from FIG. 6, an Ethernet data packet edp incoming in input area 2100 is supplied to a group of filter paths GFP which evaluate Ethernet data packet edp with regard to predefinable filter criteria and output appropriate results to evaluation stage 2104. In addition, the configuration according to FIG. 6 includes a group GIP of Internet protocol (IP) address filters, to which incoming Ethernet data packet edp is likewise supplied. As indicated in FIG. 6, output data of the individual IP address filters act as input variables on the filter paths of group GFP. In one preferred specific embodiment, group GFP of filter paths has N filter paths, and group GIP of IP address filters has J elements. If an incoming Ethernet data packet edp meets the filter criteria of multiple filter paths of group GFP, a prioritization of the multiple filter paths may be used, for example, to allow the association of an identifier chid with Ethernet data packet edp.

In one preferred specific embodiment, evaluation unit 140 is designed for assigning an identifier chid (FIG. 2) to incoming Ethernet data packets edp. For example, the measures described above with reference to FIG. 6 may be used for this purpose. For example, in function block 2108, appropriate identifiers chid (FIG. 2) may be assigned to incoming Ethernet data packets edp as a function of output data of evaluation stage 2104.

Alternatively or additionally, incoming Ethernet data packets edp may be modified, for example by removing all header data, so that only the useful data of Ethernet data packets edp are relayed to output area 2102, optionally together with identifier chid described above. Optionally, evaluation unit 140 may also discard portions of Ethernet data packets edp or entire Ethernet data packets if certain filter criteria are met (see the evaluation by unit 2104). In this case, the corresponding Ethernet data packets may also be initially relayed to output area 2102, then subjected to a segmentation by unit 130 (FIG. 2, FIG. 4), and only afterwards discarded, if necessary, for example by removal from output buffer(s) 1202, 1204. In one specific embodiment, appropriate control information 2110 may, for example, be provided by function block 2106 and optionally relayed to output terminal 120.

In one specific embodiment, output buffers 1202, 1204 may be implemented in the form of ring buffers, for example, so that discarding of data segments or data segment headers as a function of processing by evaluation unit 140 according to FIG. 6, for example, is achievable by changing a position of a write pointer on the ring buffer in question.

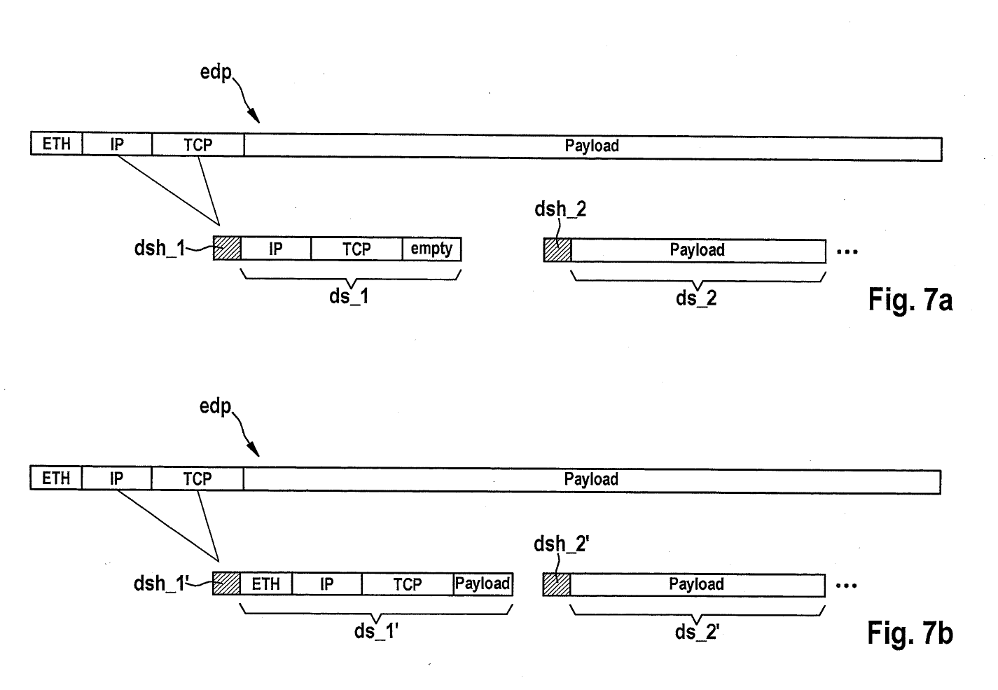

FIGS. 7a and 7b schematically show aspects of the segmentation according to further specific embodiments, which may be carried out, for example, by segmentation unit 130 according to the present invention.

FIG. 7a illustrates how an Ethernet data packet edp is segmented into multiple data segments ds_1, ds_2, . . . and multiple associated data segment headers dsh_1, dsh_2 . . . . The data segments and data segment headers thus obtained may be supplied, for example, to unit 120 according to FIG. 2.

FIG. 7b shows, in contrast to FIG. 7a, a transparent segmentation in which Ethernet data packet edp is distributed to data segments ds_1′, ds_2′ . . . and associated data segment headers dsh_1′, dsh_2′ . . . . In contrast to the specific embodiment according to FIG. 7a, data segment dsh_1′ according to FIG. 7b already contains a useful data payload, whereas a comparable area of data segment ds_1 from FIG. 7a remains empty, and the useful data of Ethernet data packet edp according to FIG. 7a are filled into second data segment ds_2 for the first time.

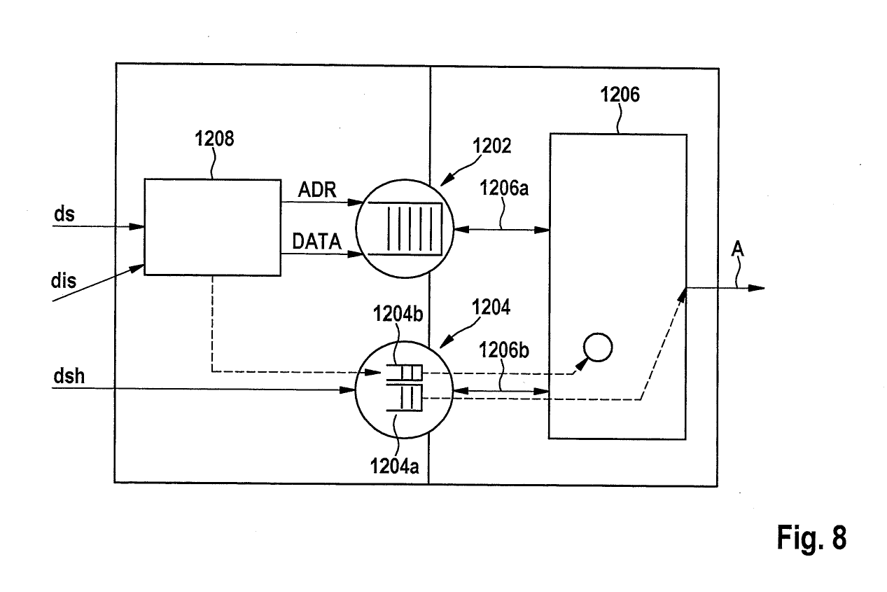

FIG. 8 schematically shows one aspect of an output interface 120 according to one specific embodiment. On the input side, data segments ds which are formed by segmentation unit 130 are supplied to a useful data write control unit 1208. In the present specific embodiment, first output buffer 1202 or its interface with useful data write control unit 1208 is implemented in such a way that it may be accessed by useful data write control unit 1208 in the same way that a static direct access memory element (SRAM, static RAM) is accessed, i.e., by specifying address information ADR and data DATA actually to be written into output buffer 1202. As is apparent from FIG. 8, data segment headers dsh are directly supplied to second output buffer 1204. Output control logic system 1206 may access first output buffer 1202 via an interface 1206a, such as on a standard first-in, first-out (FIFO) buffer memory, while the access of output control logic system 1206 takes place on second output buffer 1204 via interface 1206b in the manner of a read-ahead FIFO.

As is apparent from FIG. 8, in addition to a first buffer queue 1204a for data segment headers dsh, second output buffer 1204 may also include at least one additional buffer queue 1204b via which control information which is present is transmittable from unit 1208 to unit 1206.

In one specific embodiment, the following steps result for the operation of output interface 120 according to FIG. 8. While a data segment ds is being stored in first output buffer 1202, associated data segment header dsh is generated and then stored in second output buffer 1204. As a result, the data segment header may advantageously be read out chronologically prior to the associated data segment and output to a downstream data processing unit, not shown (see arrow A).

In another specific embodiment, it may ensue that while a data segment ds is being stored in first output buffer 1202, a simultaneous evaluation by the network interface unit or one of its components shows that portions of the considered useful data (which are segmented into one or multiple data segments) or all of the useful data (corresponding to one or multiple data segments) are to be discarded. In this case, the access to first output buffer 1202 in the manner of an SRAM is particularly advantageous, since due to the SRAM type of access, arbitrary unneeded data segments may be easily and efficiently deleted from the first output buffer. Such deletion may take place, for example, as the result of a recognized check sum error (CRC error) and the like. For the same reasons, the SRAM type of access to second output buffer 1204 is also particularly advantageous.

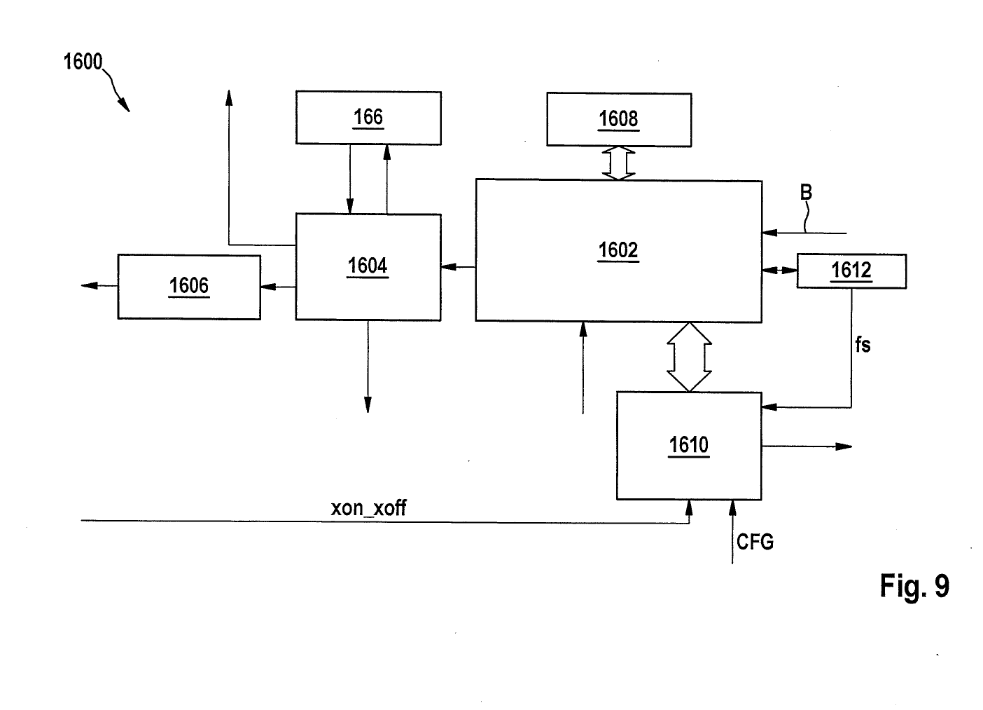

FIG. 9 schematically shows aspects of a packet processing unit 1600 according to one specific embodiment. A frame completion unit 1602 receives data (arrow B) and/or associated identifiers chid (FIG. 3) from combination unit 162, which are to be output in the form of Ethernet data packets edp″ (FIG. 3). In one specific embodiment, packet processing unit. 1600 is designed for carrying out one or more of the following functions, in particular as a function of identifier chid:
conveying data frames received from combination unit 162 (FIG. 3),
optionally completing source and/or destination addresses (MAC addresses, for example) for the header data of Ethernet data packet edp″ to be created,
optionally carrying out an ARP look-up (look-up of addresses) for this purpose in ARP database 166, in particular with the aid of frame completion unit 1602 and/or address completion unit 1604,
optionally completing header data, for example for layer 2 and/or layer 3, of the ISO/OSI base reference model,
completely regenerating data frames (in particular for XCP (Universal Measurement and Calibration Protocol) over UDP applications),
check sum generation with the aid of CRC unit 1606.

In one specific embodiment, an ARP look-up in ARP database 166 may include, for example, sending at least one IP address and receiving at least one MAC address which corresponds to the IP address.

In another specific embodiment, a so-called frame completion database 1608 may be provided which assists with the above-mentioned steps of the completion of header data.

In another specific embodiment, a traffic shaper unit 1610 may be provided for controlling the data flow within unit 1600; the traffic shaper unit may influence, among other things, the rate of Ethernet data packets edp″ to be sent, for example as a function of configuration information CFG, xon_xoff. As a result of one specific embodiment, traffic shaper unit 1610 may in particular also evaluate an operating state fs, in particular the filling state, of a buffer memory 1612 which is usable by unit 1602, for example, and may include same in the control of the data flow.

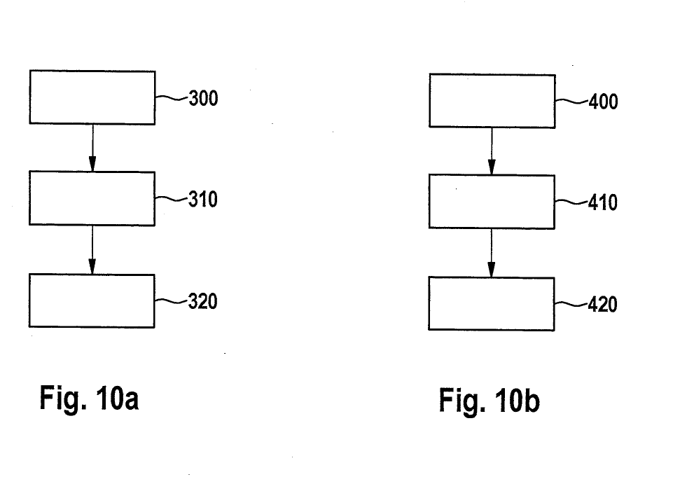

FIG. 10a schematically shows a flow chart of one specific embodiment of the method according to the present invention. At its input terminal 110, network interface unit 100a (FIG. 2) receives an incoming Ethernet data packet edp in step 300 from a physical Ethernet medium, known per se, to which network interface unit 100a is connected. Incoming Ethernet data packet edp is segmented in subsequent step 310 (FIG. 2) into at least one data segment ds having a predefinable length of 128 bytes, for example, by segmentation unit 130, for example (FIG. 2), and corresponding data segment headers dsh are preferably associated with the at least one data segment ds. The at least one data segment ds, preferably together with the data segment header(s), is output via output terminal 120 (FIG. 2) in subsequent step 320.

Optionally, in another specific embodiment of the method according to the present invention, filtering, evaluation, or modification by optional service filter unit 112 and/or evaluation unit 140 may take place between step 300 and step 310.

FIG. 10b schematically shows a flow chart of another specific embodiment of the method according to the present invention. Secondary input terminal 150 of network interface unit 100b (FIG. 4) receives incoming data segments and/or data segment headers from a data source (for example, a microprocessor which uses network interface unit 100b as an Ethernet interface) in step 400. Packet processing unit 160 forms at least one Ethernet data packet edp″ in step 410 as a function of the data segments and/or data segment headers received via secondary input terminal 150, and in step 420 the at least one Ethernet data packet edp″ is output via output terminal 170 to a physical Ethernet medium to which network interface unit 100b is connected, at least with output terminal 170.

In another preferred specific embodiment, units 120, 150 may advantageously be connected to a data sink for the data segments (in the case of unit 120) or to a data source which supplies data segments (in the case of unit 170) (in each case) via a parallel synchronous interface.

In another preferred specific embodiment, segmentation unit 130 is designed for generating data segments having a constant length of 128 bytes, for example. Due to the segmentation into data segments having a length which is constant, in particular also possibly known for downstream processing units (not shown), blockage-free data processing of the segments is advantageously made possible, and the downstream processing may take place in a particularly efficient way, even when multiple pipelines are used.

In another preferred specific embodiment, network interface unit 100, 100a, 100b according to the present invention or one or more of its components is/are implemented in hardware and/or software or firmware. In particular, the functionality according to the present invention may also be achieved by using application-specific integrated circuits (ASIC) and/or programmable logic circuits (field programmable gate arrays (FPGAs)) or generally configurable hardware circuits.

In another preferred specific embodiment, network interface unit 100, 100a, 100b according to the present invention includes a control unit (not shown) which controls the operation of network interface unit 100, 100a, 100b. However, in one particularly preferred specific embodiment, network interface unit 100, 100a, 100b may also be designed to be controlled by an external unit. For example, this may be a processing unit (not shown), situated downstream from the network interface unit according to the present invention, which receives data segments and/or data segment headers from the network interface unit 100 (FIG. 1) as input data, and/or an external processing unit which supplies network interface unit 100, in particular its secondary input terminal 150 (FIG. 3), with data segments and/or data segment headers corresponding to the data segments for conversion into one or multiple Ethernet data packets edp″. In general, a microprocessor and/or digital signal processor or a comparable arithmetic unit or functionality of the external or downstream processing units, for example, may be used for controlling network interface unit 100.

In another specific embodiment, network interface unit 100, 100a, 100b according to the present invention may also advantageously be used for implementing one or multiple flexible, high-performance Ethernet network interfaces, for example for a microprocessor or the like, the network interface unit according to the present invention supplying the microprocessor with generated data segments ds or data segment headers dsh as input data, and the microprocessor forming on an Ethernet medium Ethernet data packets edp″ to be output, as a function of data segments ds or data segment headers dsh received from the microprocessor.

In particular, by using the principle according to the present invention, an Ethernet implementation which is fully Internet Engineering Task Force (IETF)-compliant may advantageously be achieved, which at the same time offers hardware acceleration (in implementing at least some components of unit 100, for example with the aid of hardware or an FPGA, or the like) and diagnostic functions, for example when using TCP.

What is claimed is:

1. A network interface unit, comprising:
at least one input terminal for receiving Ethernet data packets;
at least one output terminal; and
a segmentation unit configured for (i) segmenting at least one of a received Ethernet data packet and an Ethernet data packet modified by the network interface unit into at least one data segment having a predefined length, and (ii) outputting the at least one data segment via the output terminal.

2. The network interface unit as recited in claim 1, wherein the segmentation unit is configured for (i) assigning a data segment header to each data segment, and (ii) outputting the data segment header via the output terminal.

3. The network interface unit as recited in claim 2, wherein the output terminal includes at least one of (i) a first output buffer for at least temporarily storing at least one data segment generated by the segmentation unit, and (ii) a second output buffer for at least temporarily storing at least one data segment header generated by the segmentation unit.

4. The network interface unit as recited in claim 2, further comprising:
an evaluation unit configured for evaluating a received Ethernet data packet as a function of at least one predefined criterion.

5. The network interface unit as recited in claim 4, wherein the evaluation unit is configured for:
(i) at least one of assigning an identifier to the received Ethernet data packet as a function of the evaluation, and modifying the received Ethernet data packet as a function of the evaluation in order to obtain a modified Ethernet data packet; and
(ii) outputting the modified Ethernet data packet to the segmentation unit.

6. The network interface unit as recited in claim 4, wherein the evaluation unit is configured for carrying out at least one of the following steps:
removing at least one predefined portion of the received Ethernet data packet; and
replacing at least one predefined portion of the received Ethernet data packet.

7. The network interface unit as recited in claim 4, further comprising:
a secondary input terminal for receiving data segments and data segment headers corresponding to the data segments; and
a packet processing unit for forming at least one Ethernet data packet as a function of at least one of the data segments and the data segment headers received via the secondary input terminal.

8. A method for operating a network interface unit, comprising:
receiving Ethernet data packets by at least one input terminal of the network interface unit; and
segmenting by a segmentation unit of the network interface unit at least one of a received Ethernet data packet and an Ethernet data packet which is modified by the network interface unit into at least one data segment having a predefined length; and
outputting, via an output terminal of the network interface unit, the at least one data segment.

9. The method as recited in claim 8, wherein the segmentation unit (i) assigns a data segment header to each data segment, and (ii) outputs the data segment header via the output terminal.

10. The method as recited in claim 9, wherein at least one of (i) the output terminal includes a first output buffer and at least temporarily stores at least one data segment generated by the segmentation unit, and (ii) the output terminal includes a second output buffer and at least temporarily stores at least one data segment header generated by the segmentation unit.

11. The method as recited in claim 9, wherein an evaluation unit performs the following:
evaluating a received Ethernet data packet as a function of at least one predefined criterion; and
at least one of (i) assigning an identifier to the received Ethernet data packet as a function of the evaluation, and (ii) modifying the received Ethernet data packet as a function of the evaluation in order to obtain a modified Ethernet data packet and outputting the modified Ethernet data packet to the segmentation unit.

12. The method as recited in claim 9, wherein the evaluation unit performs at least one of the following:
removing at least one predefined portion of the received Ethernet data packet; and
replacing at least one predefined portion of the received Ethernet data packet.

13. The method as recited in claim 9, wherein a secondary input terminal receives at least one data segment and at least one data segment header corresponding to the at least one data segment, and wherein a packet processing unit forms at least one Ethernet data packet as a function of at least one of the data segment and the data segment header received via the secondary input terminal.
